(19) United States
(12) Patent Application Publication
(10) Pub. No.: US 2011/0078413 A1
(43) Pub. Date: Mar. 31, 2011

(54) ARITHMETIC PROCESSING UNIT, SEMICONDUCTOR INTEGRATED CIRCUIT, AND ARITHMETIC PROCESSING METHOD

(75) Inventors: Hiromasa YAMAUCHI, Kawasaki (JP); Koichiro Yamashita, Kawasaki (JP)

(73) Assignee: FUJITSU LIMITED, Kawasaki-shi (JP)

(21) Appl. No.: 12/892,128

(22) Filed: Sep. 28, 2010

(30) Foreign Application Priority Data
Sep. 29, 2009 (JP) 2009-224909

(51) Int. Cl. G06F 9/302; G06F 12/00; G06F 9/30; G06F 12/08

(52) U.S. Cl. 712/207; 712/221; 711/125; 712/E09.017; 711/E12.001; 711/E12.02

(57) ABSTRACT

An arithmetic processing apparatus includes an arithmetic circuit; a first memory configured to store data to be processed in the arithmetic circuit; a second memory configured to be accessed through a first path by the arithmetic circuit; a preloader configured to preload the data from the second memory into the first memory through a second path; a memory controller configured to arbitrate between a first access by the arithmetic circuit using the first path and a second access by the preloader using the second path; and a scheduler configured to control the memory controller.

### CROSS-REFERENCE TO RELATED APPLICATIONS

This application claims the benefit of priority from Japanese Patent Application No. 2009-224909 filed on Sep. 29, 2009, the entire contents of which are incorporated herein by reference.

### BACKGROUND

1. Field

The embodiments discussed herein relate to an arithmetic processing unit, a semiconductor integrated circuit, and an arithmetic processing method.

2. Description of Related Art

An arithmetic processing unit (processor: CPU) may include a hierarchical cache memory or work memory for temporarily storing data stored in a main memory.

An arithmetic processing unit (multi-core processor) including a plurality of CPU cores includes cache memories or work memories for each of the plurality of CPU cores.

Related art is disclosed in Japanese Laid-open Patent Publication No. 07-105098 and Japanese Laid-open Patent Publication No. 11-120074 or the like.

### SUMMARY

According to one aspect of the embodiments, an arithmetic processing apparatus includes: an arithmetic circuit; a first memory configured to store data to be processed in the arithmetic circuit; a second memory configured to be accessed through a first path by the arithmetic circuit; a preloader configured to preload the data from the second memory into the first memory through a second path; a memory controller configured to arbitrate between a first access by the arithmetic circuit using the first path and a second access by the preloader using the second path; and a scheduler configured to control the memory controller.

The object and advantages of the invention will be realized and attained by at least the feature, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary arithmetic processing system;

FIG. 2 illustrates an exemplary operation of an arithmetic processing system;

FIG. 3 illustrates an exemplary arithmetic processing system;

FIG. 4 illustrates an exemplary operation of an arithmetic processing system;

FIG. 5 illustrates an exemplary operation of an arithmetic processing system;

FIG. 6 illustrates an exemplary operation of a memory controller;

FIG. 7 illustrates an exemplary operation of a memory controller;

FIG. 8 illustrates an exemplary semiconductor integrated circuit; and

FIG. 9 illustrates an exemplary arithmetic processing system.

### DESCRIPTION OF EMBODIMENTS

An arithmetic processing unit includes a preload system used for controlling preloading of data into a work memory.

While an arithmetic unit accesses a cache memory, the preload system causes a preloader to preload data for a next process operation, for example, an instruction into a work memory.

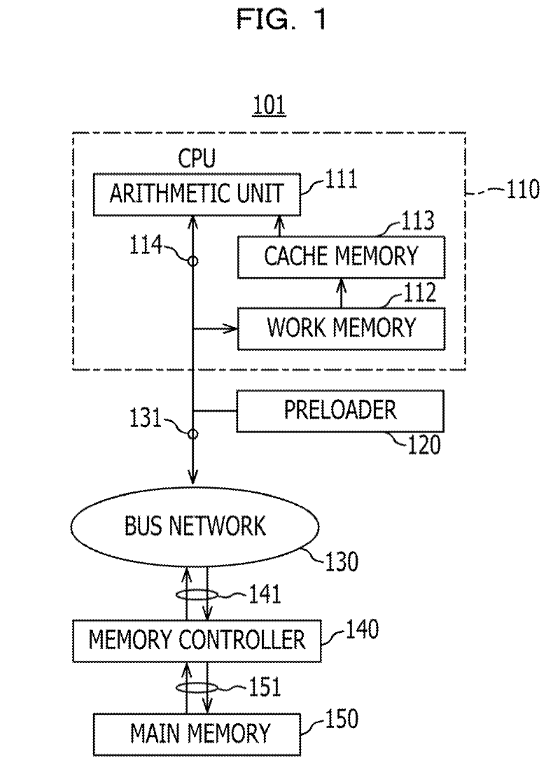

FIG. 1 illustrates an exemplary arithmetic processing system. An arithmetic processing system illustrated in FIG. 1 may include a preload system.

An arithmetic processing system 101 includes an arithmetic processing unit (processor: CPU) 110, a preloader 120, a bus network 130, a memory controller 140, and a main memory 150.

The arithmetic processing unit 110 includes an arithmetic unit 111, a work memory 112, and a cache memory 113. The arithmetic unit 111 is coupled to a bus network 130 via an internal system bus 114 and a system bus 131. The bus network 130 may include, for example, a crossbar and a multilayer bus.

In the work memory 112, data is stored that the preloader 120 preloads from the main memory 150 based on, for example, an application software instruction.

For example, the cache memory 113 reads data, for example, an instruction for a process of the arithmetic unit 111, from the main memory 150 according to a certain protocol.

For example, when a cache error occurs, the work memory 112 may be accessed.

A plurality of cache memories 113 may be hierarchically arranged inside and outside the arithmetic processing unit 110 between the arithmetic unit 111 and the main memory 150.

The work memory 112 and the preloader 120 are coupled to the bus network 130 through the system buses 114 and 131 that couple the arithmetic unit 111 to the bus network 130.

The bus network 130 is coupled to the memory controller 140 through the memory bus 141, and the memory controller 140 is coupled to the main memory 150 through the memory bus 151.

In the arithmetic processing system 101, an access path, through which the preloader 120 preloads data from the main memory 150 into the work memory 112, is also used as an access path, through which the arithmetic unit 111 accesses the main memory 150.

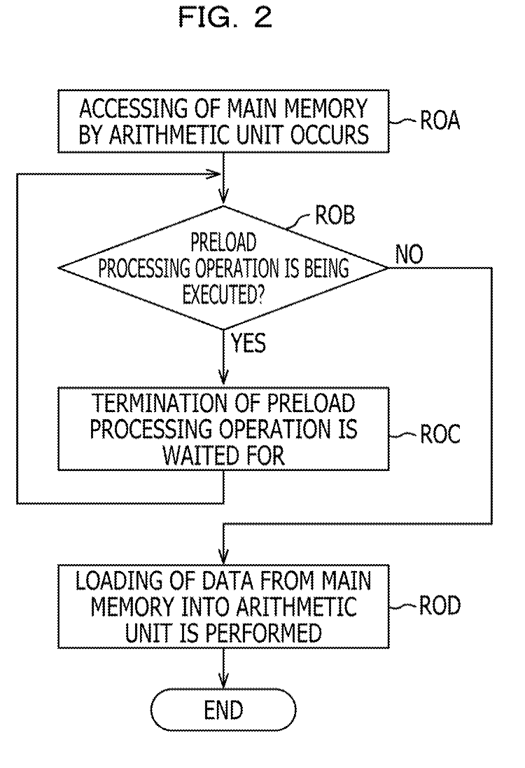

FIG. 2 illustrates an exemplary process of an operation of an arithmetic processing system. The process of the arithmetic processing system illustrated in FIG. 2 may be performed by the arithmetic processing system illustrated in FIG. 1. When the arithmetic unit 111 accesses the main memory 150 in an operation ROA, for example, based on an interrupt instruction or the like, whether preloading of data is being executed or not is determined in an operation ROB.

When preloading of data into the work memory 112 is not being executed, loading of data from the main memory 150 into the arithmetic unit 111 is terminated.

When preloading of data into the work memory 112 is being executed, the processing operation proceeds to an operation ROC. After the termination of the preloading of data, the processing operation returns to the operation ROB.

When the preloading of data is terminated, the processing operation proceeds to an operation ROD and loading of data from the main memory 150 into the arithmetic unit 111 is performed.

In the arithmetic processing system 101, an access path, through which data from the main memory 150 is preloaded into the work memory 112, may be also used as an access path, through which the arithmetic unit 111 accesses the main memory 150.

When the arithmetic unit 111 accesses the main memory 150 during the preloading of data into the work memory 112, loading of data from the main memory 150 into the arithmetic unit 111 may be performed after the preloading of data is terminated.

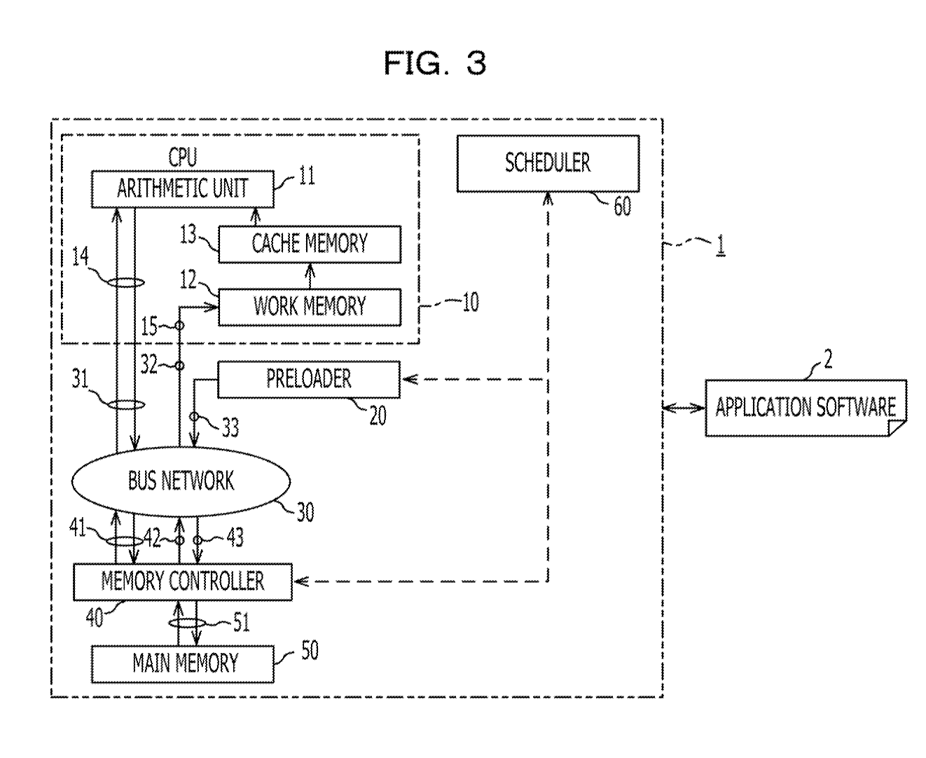

FIG. 3 illustrates an exemplary arithmetic processing system. An arithmetic processing system 1 includes an arithmetic processing unit (processor: CPU) 10, a preloader 20, a bus network 30, a memory controller 40, a main memory 50, and a scheduler 60.

The arithmetic processing unit 10 includes an arithmetic unit 11, a work memory 12, and a cache memory 13. The arithmetic unit 11 is coupled to a bus network 30 through an internal system bus 14 and a system bus 31. The bus network 30 may include, for example, a crossbar and a multilayer bus.

The preloader 20 preloads data from the main memory 50 into the work memory 12 based on an application software instruction, for example.

For example, the cache memory 13 reads data, for example, an instruction to be processed by the arithmetic unit 11 from the main memory 50 in accordance with a certain protocol. Accordingly, a delay in the main memory 50 and a bus or the like may be reduced.

A plurality of cache memories 13 may be hierarchically arranged inside and outside the arithmetic processing unit 10.

The work memory 12 is coupled to the bus network 30 through an internal memory bus 15 and a memory bus 32. The preloader 20 is coupled to the bus network 30 through a signal line 33.

The bus network 30 is coupled to the memory controller 40 through a memory bus 41 corresponding to the system bus 31 for the arithmetic unit 11, a memory bus 42 corresponding to the memory bus 32 for the work memory 12, and a signal line 43 corresponding to the signal line 33 for the preloader 20.

The arithmetic processing system 1 includes a first path through which the preloader 20 preloads data from the main memory 50 into the work memory 12 and a second path through which the arithmetic unit 11 accesses the main memory 50. The first path and the second path may be independent from each other.

The first path includes the memory buses 15, 32, and 42 between the work memory 12 and the memory controller 40 and the signal lines 33 and 43 between the preloader 20 and the memory controller 40.

The second path includes the system buses 14 and 31 and the memory bus 41 between the arithmetic unit 11 and the memory controller 40. The memory controller 40 is coupled to the main memory 50 through a memory bus 51.

The memory controller 40 may include an arbitration circuit, for example, an arbiter, used for arbitrating between individual accesses to the main memory based on control signals or the like supplied from the arithmetic unit 11, the preloader 20, and the scheduler 60.

The scheduler 60 may include software, and the scheduler 60 may control hardware of the memory controller 40. The scheduler 60 may include software, for example, resident software, executed by the arithmetic processing unit 10, for example, the arithmetic unit 11 at an initializing operation when the arithmetic processing system is started up.

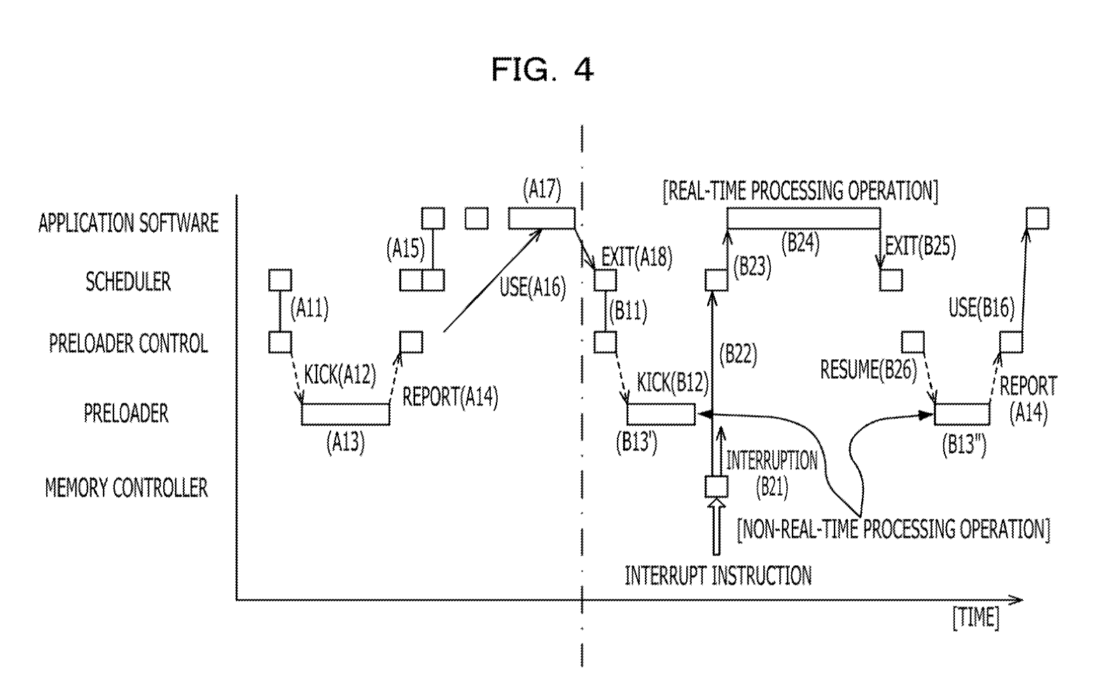

FIG. 4 illustrates an exemplary operation of an arithmetic processing system. A left-hand segment of FIG. 4 illustrates an operation performed when no access of the main memory by the arithmetic unit occurs during a normal preload operation, for example, preloading of data from the main memory into the work memory.

A right-hand segment of FIG. 4 illustrates an operation performed when the arithmetic unit accesses the main memory during preloading of data from the main memory into the work memory.

As illustrated in the left-hand segment of FIG. 4, in the normal preload operation, an instruction for preloader control is issued from the scheduler 60 (A11), and a kick instruction is input to the preloader 20 (kick: A12).

Data is transferred from the main memory 50 to the work memory 12 via the memory buses 51, 42, 32, and 15, the memory controller 40, and the bus network 30 (A13). In addition, when the data transfer is terminated, a report of the transfer termination is output (report: A14).

An application software uses data preloaded into the work memory 12 (use: A16), executes a certain operation (A17), and completes the operation (exit: A18).

As illustrated in the right-hand segment of FIG. 4, for example, the arithmetic unit 11 may access the main memory 50 based on an interrupt instruction during the preloading of data from the main memory 50 into the work memory 12.

The scheduler 60 issues an instruction for preloader control (B11), and a kick instruction is input to the preloader 20 (kick: B12). Data transfer from the main memory 50 to the work memory 12 is started through the memory buses 51, 42, 32, and 15, the memory controller 40, and the bus network 30 (B13′).

For example, when the arithmetic unit 11 accesses the main memory 50 based on an interrupt instruction, the memory controller 40 interrupts the preloading of data from the main memory 50 into the work memory 12, performed by the preloader 20 (B21).

The arithmetic unit 11 accesses the main memory 50 (B23), and imports data from the main memory 50 via the memory buses 51 and 41, the system buses 31 and 14, the memory controller 40, and the bus network 30 (B24).

When the access to the main memory 50 by the arithmetic unit 11 is completed (exit: B25), the preloader 20 resumes the preloading of data from the main memory 50 into the work memory 12 (B26).

The transfer of data from the main memory 50 to the work memory 12 through the memory buses 51, 42, 32, and 15, the memory controller 40, and the bus network 30 (B13″) is resumed.

When the data transfer, for example, the preloading of data into the work memory 12 is terminated, a termination report is output (report: B14), and the application software uses data preloaded into the work memory 12 (use: B16).

For example, access to the main memory 50 by the arithmetic unit 11 based on an interrupt instruction may be performed in real-time. The preloading of data from the main memory 50 into the work memory 12 may be performed in non-real-time.

The real-time operation may be performed in response to an input signal from another device or a request from a program, and examples of the real-time processing operation may include replying to a telephone call and brake controlling for a car.

In the real-time operation, an operation in a control system is terminated in a certain amount of time, for example.

In the non-real-time operation, an operation may not be terminated in a certain amount of time. In addition, examples of the non-real-time processing operation may include generating a mail and a document in a mobile phone.

In FIG. 4, preloading of data into the work memory 12, which corresponds to the non-real-time operation, may include the transfer of data including a request or a response (Request/Response) by a direct memory access controller (DMAC), for example.

When an arbitration circuit, for example, the memory controller 40, switches an access by the DMAC, for example, preloading of data, to an access to the arithmetic unit 11, the DMAC may not seem to respond.

In the preloading of data into the work memory 12, transmitted data (B13′) is held based on an interruption (B21), and next access is waited for. Therefore, the preloading of data is resumed (B26), and subsequent data (B12″) is transmitted and held.

The time of the interruption (B21) illustrated in FIG. 4 includes a timing when an arbitration mechanism, for example, the memory controller 40 switches to an access to the arithmetic unit 11.

For example, the priority of a preload operation is set to a low priority, and hence the arithmetic unit 11 may access the main memory 50 during the preloading of data into the work memory 12.

The scheduler 60 may include resident software. For example, the scheduler 60 may refer to a table in which priorities are preliminarily assigned to individual operations, and cause the memory controller 60 to arbitrate based on the priorities.

For example, a certain priority may be assigned to the operation of the arithmetic unit 11, and a variable priority may be assigned to the control operation of the preloader, for example, preloading of data from the main memory 50 into the work memory 12.

A plurality of interrupt operations don't occur contemporaneously. For example, a first come first serve (FCFS) method may be adopted. An operation to be switched may include an operation having the lowest priority among operations that are being executed.

For example, when a request for a real-time operation occurs based on an interrupt instruction, a high priority, for example, the maximum priority, may be assigned to the real-time operation. In addition, the priority of the preloader control operation corresponding to a non-real-time operation may be changed to a low priority, for example, the minimum priority.

The attributes are assigned to the real-time operation and the non-real-time operation. Accordingly, when the arithmetic unit 11 access the main memory 50 during the preloading of data into the work memory 12, an arbitration operation is performed based on the priorities.

For example, the scheduler 60 may lower the priority of the preloading of data into the work memory 12 as compared with the priority of the access to the main memory 50 by the arithmetic unit 11. Since the memory controller 40 determines the order of access based on the priorities, the preload may be interrupted.

Priorities may be assigned to a real-time operation processing and a non-real-time operation in a mobile phone, respectively, for example. Each of the priorities may be set to one of “high”, “middle”, and “low”.

The real-time operation may include a call operation or a graphical user interface (GUI) operation. In addition, the non-real-time operation may include data communication based on a browser.

In Internet access service using a mobile telephone network, when an e-mail message is generated while audio data is downloaded in the background, a response to a character entry may be delayed.

For example, “high” may be assigned to the priority of the call operation, “middle” may be assigned to the priority of the character entry, and “low” may be assigned to the priority of the download of audio data.

When a user starts a character entry operation during the download of audio data, a context switch may occur. The control of the DMAC that performs a download may be interrupted, and the character entry operation may be executed. A telephone call may cause the character entry operation to be interrupted and a call operation may be performed.

The arithmetic system described above may respond in a real-time with a high throughput.

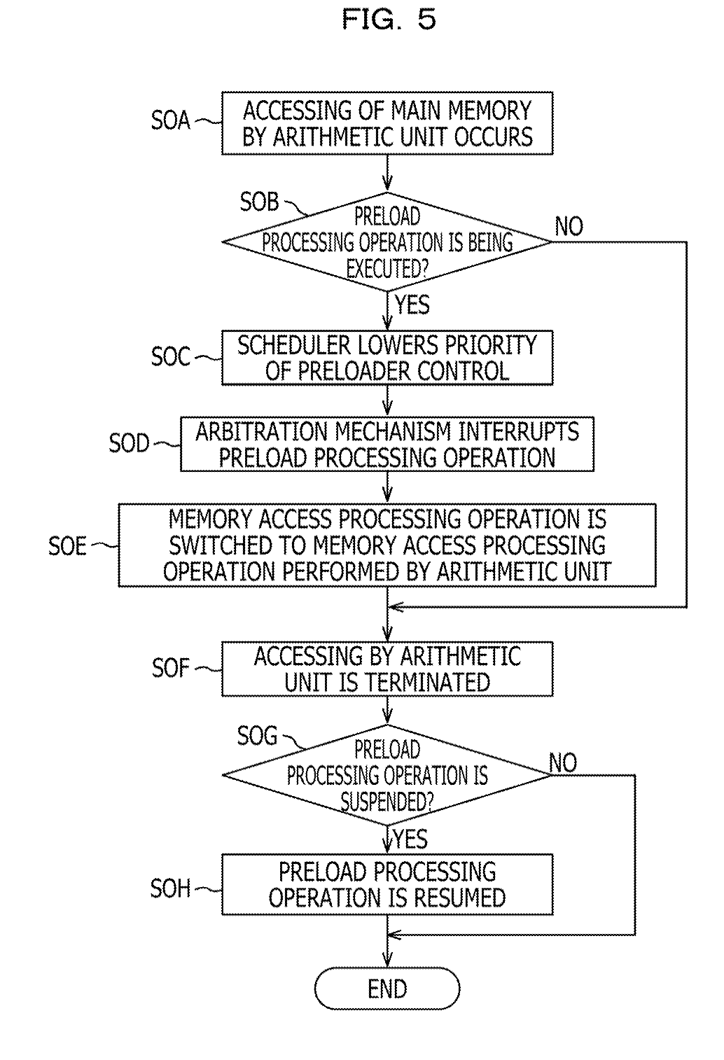

FIG. 5 illustrates an exemplary process of an operation of an arithmetic processing system. The process of the arithmetic processing system illustrated in FIG. 3 may be performed by the arithmetic processing system illustrated in FIG. 3. When the arithmetic unit accesses the main memory while data is preloaded from the main memory into the work memory, the remote controller performs an arbitration operation.

When the arithmetic unit 11 accesses the main memory 50 in an operation SOA, for example, based on an interrupt instruction or the like, it is determined whether preloading of data into the work memory 12 is being executed in an operation SOB.

When preloading of data from the main memory 50 into the work memory 12 is being executed, the scheduler 60 lowers the priority of preloader control (instruction) in an operation SOC.

In an operation SOD, an arbitration circuit, for example, the memory controller 50, performs an arbitration operation, and interrupts the preloading of data into the work memory 12, which is being executed and the priority of which is lowered. In an operation SOE, a memory access operation is switched to an access operation performed by the arithmetic unit 11. The arithmetic unit 11 accesses the main memory 50.

In an operation SOF, when the access to the main memory 50 by the arithmetic unit 11 is terminated, it is determined whether preloading of data into the work memory 12 is suspended in an operation SOG.

When the preloading of data from the main memory 50 into the work memory 12 is suspended, the preloading of data following the interruption into the work memory 12 is resumed in an operation SOH.

When the preloading of data from the main memory 50 into the work memory 12 is not suspended, for example, the preloading of data into the work memory 12 has been completed before the preloading of data is interrupted in the operation SOD, the operation is terminated.

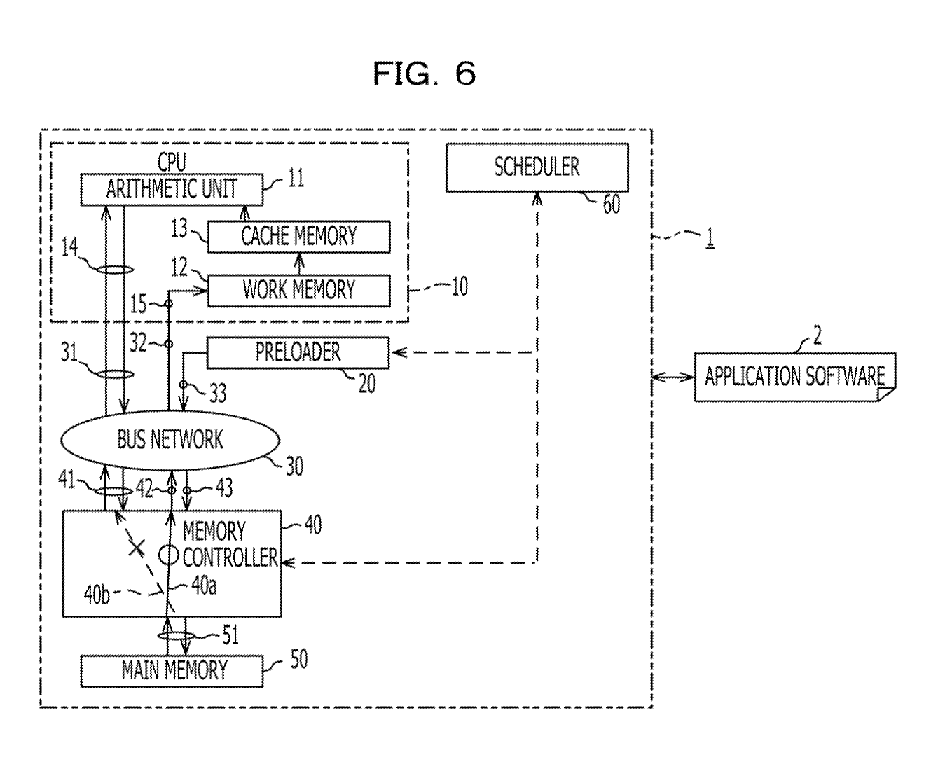

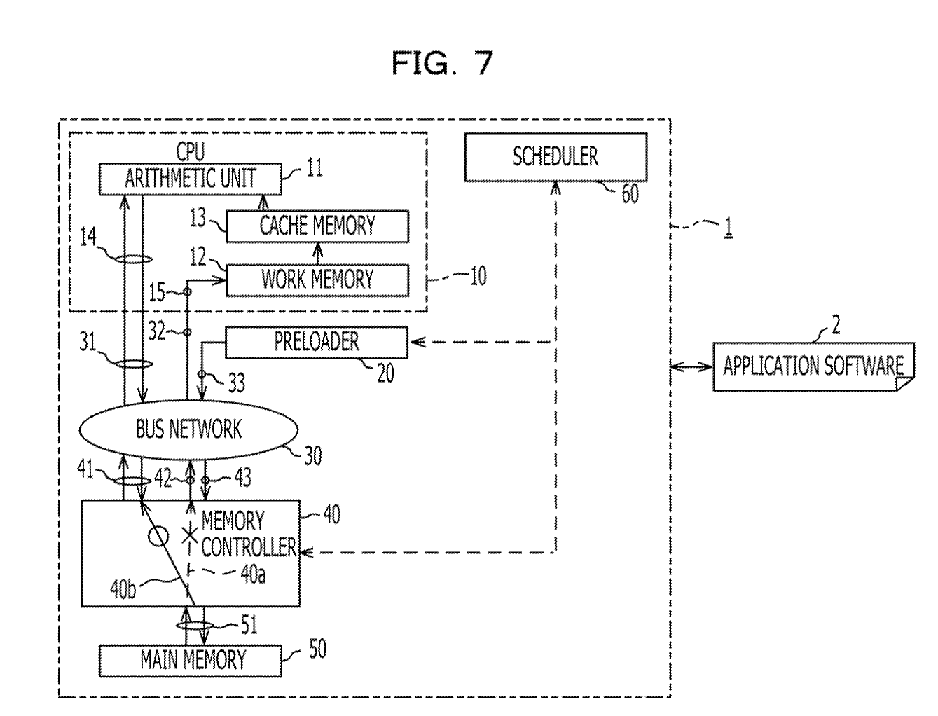

FIGS. 6 and 7 illustrate an exemplary arbitration operation. The arbitration operation illustrated in FIGS. 6 and 7 may be performed by the memory controller 40 in the arithmetic processing system illustrated in FIG. 3.

In FIG. 6, data may be preloaded from the main memory 50 into the work memory 12. In FIG. 7, the arithmetic unit 11 may access the main memory 50.

As illustrated in FIG. 6, when data is preloaded from the main memory 50 into the work memory 12, the memory controller 40 couples the memory bus 51, which extends from the main memory 50, to the memory bus 42 that extends to the bus network 30. The bus network 30 may include, for example, a crossbar and a multilayer bus.

For example, the memory controller 40 may disable a path 40b and enable a path 40a. Data may be preloaded from the main memory 50 into the work memory 12 through a first path extending from the memory bus 51, to the memory controller 40 (the path 40a), to the memory bus 42, to the bus network 30, to the memory bus 32, and then to the internal memory bus 15 (51 [symbol] 40 (40a) [symbol] 42 [symbol] 30 [symbol] 32 [symbol] 15).

As illustrated in FIG. 7, when the arithmetic unit 11 accesses the main memory 50, the memory controller 40 couples the memory bus 41, which extends from the bus network 30, to the memory bus 51 that extends to the main memory 50. The bus network 30 may include, for example, a crossbar and a multilayer bus.

For example, the memory controller 40 may disable the path 40a and enable the path 40b. The arithmetic unit 11 accesses the main memory 50 through a second path including the internal system bus 14, the system bus 31, the bus network 30, the memory bus 41, the memory controller 40 (the path 40b), and the memory bus 51 (14 [symbol] 31 [symbol] 30 [symbol] 41 [symbol] 40 (40b) [symbol] 51).

When the arithmetic unit 11 accesses the main memory 50 during the preloading of data from the main memory 50 into the work memory 12, the preloading of data is interrupted. In addition, when the access to the main memory 50 by the arithmetic unit 11 is completed, the operation returns to the state illustrated in FIG. 6.

An arbitration operation performed by the memory controller 40 may be controlled by the scheduler 60 including software. The scheduler 60 may assign a low priority to preloading of data, for example.

In the arithmetic processing system 1, when the arithmetic unit 11 accesses the maim memory 50 during the preloading of data into the work memory 12, the scheduler 60 may change the priority of the preloading of data.

The memory controller 40 may perform an arbitration operation based on a priority assigned by the scheduler 60.

If an independent access path, for example, the first path or the second path is set as the internal bus of the semiconductor integrated circuit 200, the preloading of data may be interrupted, and hence access to the main memory 50 by the arithmetic unit 11 may be performed with the latency of a number of clocks.

For example, by arbitrating between the access to the main memory 50 by the arithmetic unit 11 and the access to the main memory 50 by the preloader 20, the stalling of the arithmetic unit 11 may be reduced, and hence the throughput of the arithmetic unit 11 may be increased.

Since the stalling of the arithmetic unit 11 is reduced, performance may be improved by several tens of percents, for example. A response operation is performed in real time, and hence a high-speed interruption operation may be performed.

For example, when an interruption operation such as a user interface (UI) operation or the like is performed during the reproduction of the motion picture in the motion picture content of a mobile phone or the like in which “file system plus stream data control” are performed, the stalling of the UI operation due to the look-ahead caching of data of the motion picture content may be reduced.

For example, while the preloading of data into the work memory does not interrupt the reproduction of the motion picture, the UI operation may be performed in real-time.

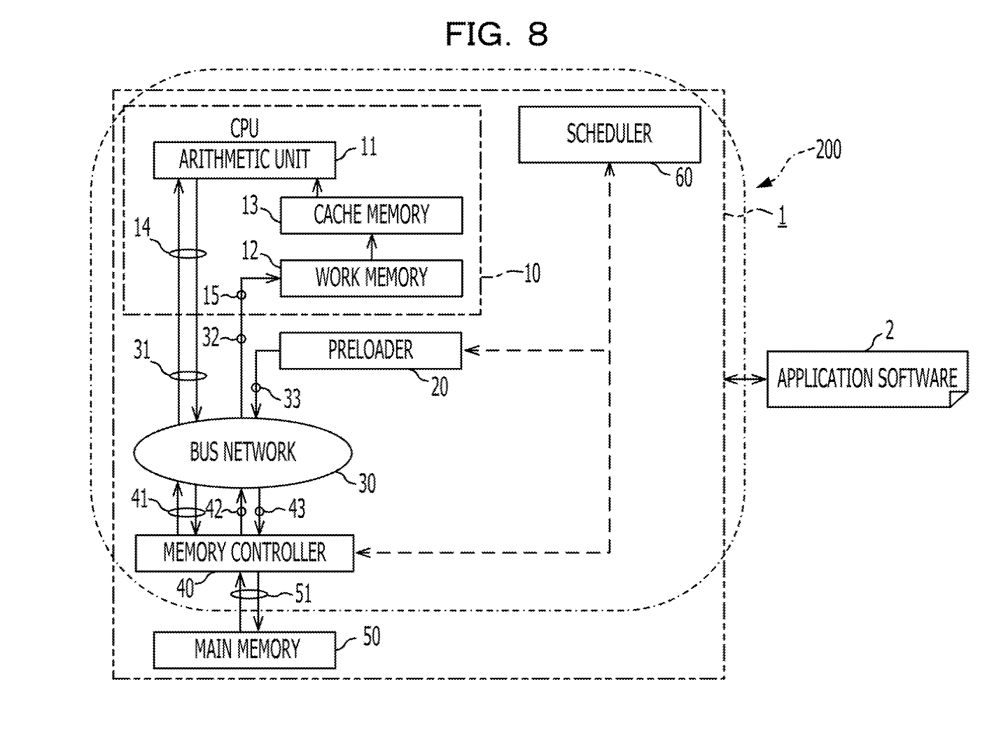

FIG. 8 illustrates an exemplary semiconductor integrated circuit. A semiconductor integrated circuit 200 may not include the main memory 50 illustrated in FIG. 3.

The semiconductor integrated circuit 200 may be an LSI or a semiconductor IP which includes hardware having the arithmetic processing unit 10, the preloader 20, the bus network 30, and the memory controller 40 and software having the scheduler 60.

Another LSI that includes the arithmetic processing unit 10, the preloader 20, the bus network 30, and the memory controller 40 may be provided. The bus network 30 may include, for example, a crossbar and a multilayer bus.

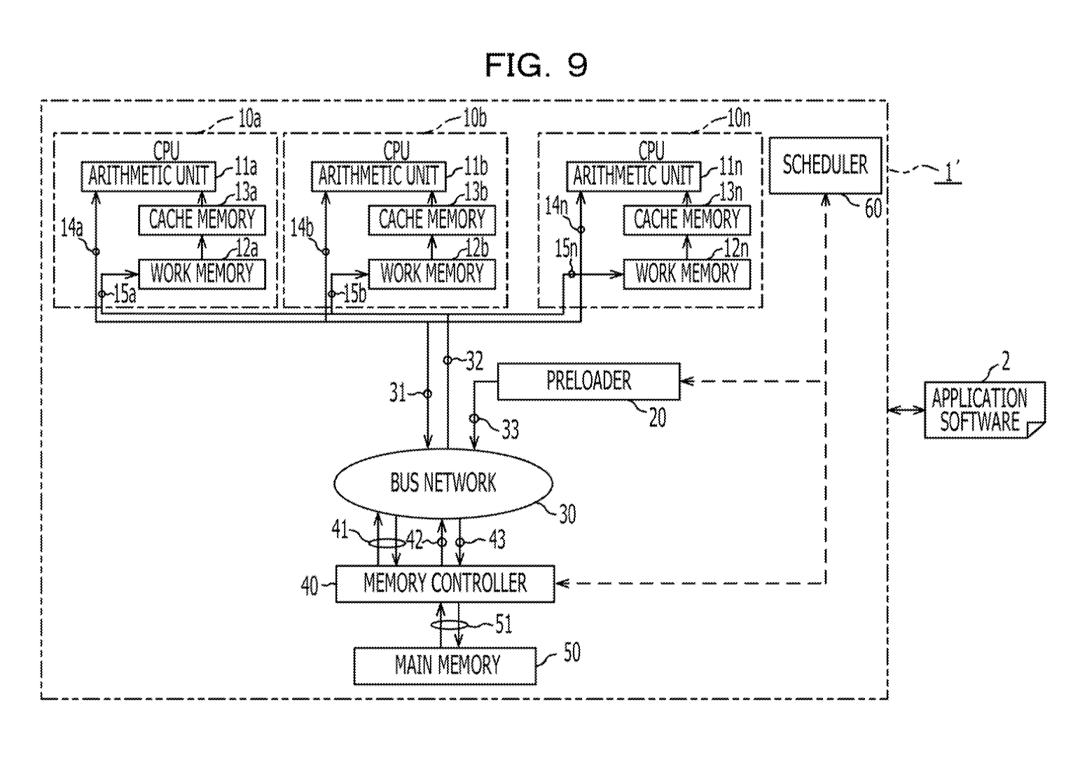

FIG. 9 illustrates an exemplary arithmetic processing system.

An arithmetic processing system 1′ illustrated in FIG. 9 may be a multiprocessor that includes a plurality of arithmetic processing units 10a to 10n, for example, a plurality of CPU cores. The plurality of arithmetic processing units 10a to 10n may be similar to the arithmetic processing unit 10 illustrated in FIG. 3.

The arithmetic processing system 1′ includes the preloader 20, the bus network 30, the memory controller 40, the main memory 50, and the scheduler 60, which are shared by the arithmetic processing units 10a to 10n, and the arithmetic processing units 10a to 10n. The bus network 30 may include, for example, a crossbar and a multilayer bus.

The arithmetic processing units 10a to 10n include arithmetic units 11a to 11n, work memories 12a to 12n, and cache memories 13a to 13n, respectively.

The arithmetic units 11a to 11n are coupled to the bus network 30 through internal system buses 14a to 14n in the arithmetic processing units 10a to 10n and the system bus 31, respectively.

The work memories 12a to 12n are coupled to the bus network 30 through internal memories bus 15a to 15n in the arithmetic processing units 10a to 10n and the memory bus 32, respectively.

The semiconductor integrated circuit may be provided as an LSI or a semiconductor IP that includes the arithmetic processing system 1′ including no main memory. Another LSI, which includes the arithmetic processing units 10a to 10n, the preloader 20, the bus network 30, and the memory controller 40 or the like, may be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

1. An arithmetic processing apparatus comprising:
an arithmetic circuit;
a first memory configured to store data to be processed in the arithmetic circuit;
a second memory configured to be accessed through a first path by the arithmetic circuit;
a preloader configured to preload data from the second memory into the first memory through a second path;
a memory controller configured to arbitrate between a first access by the arithmetic circuit using the first path and a second access by the preloader using the second path; and
a scheduler configured to control the memory controller.

2. The arithmetic processing apparatus according to claim 1, wherein the memory controller includes hardware and the scheduler includes software.

3. The arithmetic processing apparatus according to claim 1, wherein the second memory includes a main memory, and
wherein the first memory includes a work memory that temporarily stores the data preloaded from the main memory.

4. The arithmetic processing apparatus according to claim 1, further comprising:
a cache memory configured to cache the data to be processed in the arithmetic unit.

5. The arithmetic processing apparatus according to claim 1, wherein when the preloader preloads the data from the second memory into the first memory and the arithmetic circuit accesses the second memory, the memory controller interrupts a preload operation and permits the arithmetic circuit to access the second memory.

6. The arithmetic processing apparatus according to claim 5, wherein the scheduler sets priorities on at least two operations and arbitrates the operations based on the priorities.

7. The arithmetic processing apparatus according to claim 6, wherein the scheduler assigns a first priority to the preload operation; and
the scheduler changes a priority of the preload operation to a low priority when the preloader preloads data from the second memory into the first memory and the arithmetic circuit accesses the second memory.

8. The arithmetic processing apparatus according to claim 1, wherein the first path and the second path are independent from each other.

9. A semiconductor integrated circuit comprising:
an arithmetic processing circuit;
a first memory configured to store data to be processed in the arithmetic processing circuit;
a preloader configured to preload the data from a second memory into the first memory through a second path;
a memory controller configured to arbitrate between a first access by the arithmetic processing circuit using the first path and a second access by the preloader using the second path; and
a scheduler configured to control the memory controller.

10. The semiconductor integrated circuit according to claim 9, wherein the memory controller includes hardware and the scheduler includes software.

11. The semiconductor integrated circuit according to claim 9, wherein the second memory includes a main memory and the first memory includes a work memory that stores data preloaded from the main memory.

12. The semiconductor integrated circuit according to claim 9, further comprising:
a cache memory configured to cache the data to be processed in the arithmetic processing circuit.

13. The semiconductor integrated circuit according to claim 9, wherein when the preloader preloads data from the second memory into the first memory and the arithmetic processing circuit accesses the second memory, the memory controller interrupts a preload operation and permits the arithmetic processing circuit to access the second memory.

14. The semiconductor integrated circuit according to claim 13, wherein the scheduler sets priorities on at least two operations and arbitrates the operations based on the priorities.

15. The semiconductor integrated circuit according to claim 14, wherein the scheduler assigns a first priority to the preload operation; and
the scheduler changes a priority of the preload operation to a low priority when the preloader preloads data from the second memory into the first memory and the arithmetic processing circuit accesses the second memory.

16. The semiconductor integrated circuit according to claim 9, wherein the first path and the second path are independent from each other.

17. The semiconductor integrated circuit according to claim 9, further comprising:
a bus network configured to be arranged between the memory controller and the arithmetic processing circuit.

18. The semiconductor integrated circuit according to claim 9, wherein the arithmetic processing circuit includes a plurality of arithmetic circuits, and
wherein the preloader controls preload operations instructed by the plurality of arithmetic circuits.

19. An arithmetic processing method comprising:
temporarily storing data to be processed in an arithmetic circuit in a first memory;
preloading the data from a second memory into the first memory through a first path; and
arbitrating between a first access to the second memory through a second path and a second access to the second memory through the first path,
wherein a preload operation is interrupted and the arithmetic circuit accesses the second memory when the data is preloaded from the second memory into the first memory and an access to the second memory by the arithmetic circuit occurs.
